(19) United States
(12) Patent Application Publication
(10) Pub. No.: US 2018/0237046 A1
(43) Pub. Date: Aug. 23, 2018

(54) ALL-TERRAIN MULTIPURPOSE UTILITY VEHICLE FOR GOODS TRANSPORT AND ENTERTAINMENT IN BEACH

(71) Applicant: Constantino Bovino, Piscataway, NJ (US)

(72) Inventor: Constantino Bovino, Piscataway, NJ (US)

(21) Appl. No.: 15/958,533

(22) Filed: Apr. 20, 2018

Related U.S. Application Data
(60) Provisional application No. 62/487,798, filed on Apr. 20, 2017.

(51) Int. Cl. B62B 3/00; B62D 55/06; B62B 3/02; B60L 8/00

(52) U.S. Cl. CPC B62B 3/007; B62D 55/06; B62B 3/002; B62B 3/02; B60L 2230/22; B62B 2202/52; B60L 2200/30; B62B 2501/065; B60L 8/003

(57) ABSTRACT

A beach tank for carrying a plurality of beach items is disclosed. The beach tank includes a rectangular shaped wagon mounted on a pair of caterpillar tracks, where each caterpillar track is arranged underneath a longitudinal edge of the wagon. An electric motor mounted on an underside of the wagon is configured to operate the pair of caterpillar tracks for moving the wagon on a plurality of terrains. A plurality of storage compartments are positioned along an exterior surface of the wagon, such that each storage compartment is configured to house the plurality of beach items.

### CROSS-REFERENCE TO RELATED APPLICATION

The embodiments herein claims the priority of the U.S. Provisional Patent Application with Ser. No. 62/487,798 filed on Apr. 20, 2017 with the title, “BEACCH TANK”, and the contents of which are included entirely as reference herein.

### BACKGROUND

### Technical Field

The embodiments herein are generally related to the field of travelling and camping equipments. The embodiments herein are particularly related to an all-terrain vehicle used for carrying recreational items used at a beach. The embodiments herein are more particularly related to an all-terrain multipurpose utility vehicle for carrying recreational and sport items used at a beach.

### Description of the Related Art

Recreational activities in warm seasons often include outings to beaches. Typically, various items such as tables, chairs, umbrella, Wi-Fi connectors, charging station, water, eateries, anti-tan lotion, moisturizer, and such other supplies are required by people venturing to spend quality time at a beach. Often, such items need to be carried from a house, a car or a vehicle to a location on the beach for use. As a result, one is required to make several trips from the car or the vehicle to the location on the beach for transporting the items.

Various beach transporting apparatus exist in prior art for purpose of transporting beach utilities and supplies. However existing beach transporting apparatus are heavy and difficult to maneuver on various terrains such as sandy surfaces and pavements. Further, the existing beach carts fail to encompass electrical connectivity and various other electronic facilities that ensure connectivity and convenience.

Hence there is a need for a versatile beach transporting apparatus that is maneuvered across all terrains. Further, there is need for an alternate beach transporting apparatus for providing a network connectivity at the beach. Still further there is a need for an all-terrain multipurpose utility vehicle for carrying recreational and sport items used at a beach. Yet further there is a need for a multipurpose utility vehicles for use in picnic spots, camps, tourist places, malls, and sports stadiums.

The above-mentioned shortcomings, disadvantages, and problems are addressed herein and which will be understood by reading and studying the following specification.

### Objectives of the Embodiments Herein

A primary object of the embodiments herein is to provide a beach tank or beach carrier that is light weight and is easily maneuvered on a plurality of terrains such as sandy surfaces and pavements.

Another object of the embodiments herein is to provide a versatile beach tank that is designed to carry a plurality of items such as towels, food, water, beverages, chairs, umbrella, anti-tan lotion, clothes, tables, charging ports, speakers, wi-fi connectors, and other utilities that are required at a beach.

Yet another object of the embodiments herein is to provide a beach tank that is driven by a remote controlled electric motor.

Yet another object of the embodiments herein is to provide a beach tank that is manually pulled by a handle provided at a front portion of a body of the beach tank.

Yet another object of the embodiments herein is to provide a beach tank with solar panels that is designed for supplying the electrical energy required for operating various electronic appliances in the beach tank.

Yet another object of the embodiments herein is to provide a beach tank that is structured to collapse inwardly when not in use to facilitate a compact storage and easier transport in a car or a vehicle.

Yet another object of the embodiments herein is to provide a beach tank in a plurality of colors and sizes to make it appealing to a wide range of users.

Yet another object of the embodiments herein is to provide a versatile beach transporting apparatus that is maneuvered across all terrains.

Yet another object of the embodiments herein is to provide an alternate beach transporting apparatus for providing a network connectivity at the beach.

Yet another object of the embodiments herein is to provide an all-terrain multipurpose utility vehicle for carrying recreational and sport items used at a beach.

Yet another object of the embodiments herein is to provide a multipurpose utility vehicles for use in picnic spots, camps, tourist places, malls, and sports stadiums.

These and other objects and advantages of the embodiments herein will become readily apparent from the following detailed description taken in conjunction with the accompanying drawings.

### SUMMARY

These and other aspects of the embodiments herein will be better appreciated and understood when considered in conjunction with the following description and the accompanying drawings. It should be understood, however, that the following descriptions, while indicating preferred embodiments and numerous specific details thereof, are given by way of illustration and not of limitation. Many changes and modifications may be made within the scope of the embodiments herein without departing from the spirit thereof, and the embodiments herein include all such modifications.

The following details present a simplified summary of the embodiments herein to provide a basic understanding of the several aspects of the embodiments herein. This summary is not an extensive overview of the embodiments herein. It is not intended to identify key/critical elements of the embodiments herein or to delineate the scope of the embodiments herein. Its sole purpose is to present the concepts of the embodiments herein in a simplified form as a prelude to the more detailed description that is presented later.

The embodiments herein disclose an all-terrain multipurpose utility vehicle for carrying recreational and sport items used at a beach. The embodiments herein disclose an all-terrain multipurpose utility vehicles for use in picnic spots, camps, tourist places, malls, and sports stadiums. According to an embodiment herein, a beach tank is provided. The beach tank comprises a rectangular/square shaped wagon mounted on a pair of caterpillar tracks. Each caterpillar track is arranged underneath a longitudinal edge of the wagon. An electric motor is mounted on an underside of the wagon and configured to operate the pair of caterpillar tracks for moving the wagon on a plurality of terrains. A plurality of storage compartments is positioned along an exterior surface of the wagon. Each storage compartment is configured to house or accommodate or store a plurality of beach items.

According to an embodiment herein, the beach tank further comprises a handle provided at a front end of the wagon. The handle is configured to facilitate maneuvering/pulling of the wagon manually.

According to an embodiment herein, the beach tank further includes a beach umbrella mounted on a support rod attached to an interior/inner side of the wagon for providing a shade.

According to an embodiment herein, the beach tank further comprises a strap provided at the interior/inner end of the wagon to anchor the support rod of the beach umbrella.

According to an embodiment herein, the beach umbrella is folded into a binding cylinder and clamped into the binding cylinder.

According to an embodiment herein, the beach tank further comprises a charging station provided with one or more electrical power outlets, a Universal Service Bus (USB) port, speakers, Wi-Fi, and Bluetooth connectivity.

According to an embodiment herein, the beach tank further comprises a solar panel mounted behind the USB port and configured to provide electric power to the charging station and a plurality of rechargeable batteries that are configured to operate the electric motor and a plurality of electrical and electronic equipments.

According to an embodiment herein, the solar panel is further configured to flip open, when the beach tank is stationed at a desired location.

According to an embodiment herein, a length of the wagon is upto five feet, a width of the wagon is within a range of two to three feet and a height of the wagon is upto 3 feet.

According to an embodiment herein, the wagon is made of at least one of a lightweight weatherproof plastic material and a metallic material.

According to an embodiment herein, the wagon and the plurality of storage compartments are provided in a plurality of colors.

According to an embodiments herein, the plurality of beach items comprises one or more of blankets, towels, food, water, cleaning solution, carpets, chairs, beverages, umbrellas, tables, mobile phones, stereos, body lotions, amusement goods, sports goods, toys, and clothes.

According to an embodiment herein, the beach tank is further configured to tailgate a motorized vehicle.

These and other aspects of the embodiments herein will be better appreciated and understood when considered in conjunction with the following description and the accompanying drawings. It should be understood, however, that the following descriptions, while indicating the preferred embodiments and numerous specific details thereof, are given by way of an illustration and not of a limitation. Many changes and modifications may be made within the scope of the embodiments herein without departing from the spirit thereof, and the embodiments herein include all such modifications.

### BRIEF DESCRIPTION OF THE DRAWINGS

The other objects, features, and advantages will be apparent to those skilled in the art from the following description of the preferred embodiment herein and the accompanying drawings in which:

FIG. 1 illustrates a perspective view of a beach tank, according to an embodiment herein.

Although the specific features of the embodiments herein are shown in some drawings and not in others. This is done for convenience only as each feature may be combined with any or all of the other features in accordance with the embodiments herein.

### DETAILED DESCRIPTION OF THE EMBODIMENTS HEREIN

In the following detailed description, a reference is made to the accompanying drawings that form a part hereof, and in which the specific embodiments that may be practiced is shown by way of illustration. These embodiments are described in sufficient detail to enable those skilled in the art to practice the embodiments and it is to be understood that the logical, mechanical and other changes may be made without departing from the scope of the embodiments. The following detailed description is therefore not to be taken in a limiting sense.

The embodiments herein disclose an all-terrain multipurpose utility vehicle for carrying recreational and sport items used at a beach. The embodiments herein disclose an all-terrain multipurpose utility vehicles for use in picnic spots, camps, tourist places, malls, and sports stadiums. According to an embodiment herein, a beach tank is provided. The beach tank comprises a rectangular/square shaped wagon mounted on a pair of caterpillar tracks. Each caterpillar track is arranged underneath a longitudinal edge of the wagon. An electric motor is mounted on an underside of the wagon and configured to operate the pair of caterpillar tracks for moving the wagon on a plurality of terrains. A plurality of storage compartments is positioned along an exterior surface of the wagon. Each storage compartment is configured to house or accommodate or store a plurality of beach items.

According to an embodiment herein, the beach tank further comprises a handle provided at a front end of the wagon. The handle is configured to facilitate maneuvering/pulling of the wagon manually.

According to an embodiment herein, the beach tank further includes a beach umbrella mounted on a support rod attached to an interior/inner side of the wagon for providing a shade.

According to an embodiment herein, the beach tank further comprises a strap provided at the interior/inner end of the wagon to anchor the support rod of the beach umbrella.

According to an embodiment herein, the beach umbrella is folded into a binding cylinder and clamped into the binding cylinder.

According to an embodiment herein, the beach tank further comprises a charging station provided with one or more electrical power outlets, a Universal Service Bus (USB) port, speakers, Wi-Fi, and Bluetooth connectivity.

According to an embodiment herein, the beach tank further comprises a solar panel mounted behind the USB port and configured to provide electric power to the charging station and a plurality of rechargeable batteries that are configured to operate the electric motor and a plurality of electrical and electronic equipments.

According to an embodiment herein, the solar panel is further configured to flip open, when the beach tank is stationed at a desired location.

According to an embodiment herein, a length of the wagon is upto five feet, a width of the wagon is within a range of two to three feet and a height of the wagon is upto 3 feet.

According to an embodiment herein, the wagon is made of at least one of a lightweight weatherproof plastic material and a metallic material.

According to an embodiment herein, the wagon and the plurality of storage compartments are provided in a plurality of colors.

According to an embodiments herein, the plurality of beach items comprises one or more of blankets, towels, food, water, cleaning solution, carpets, chairs, beverages, umbrellas, tables, mobile phones, stereos, body lotions, amusement goods, sports goods, toys, and clothes.

According to an embodiment herein, the beach tank is further configured to tailgate a motorized vehicle.

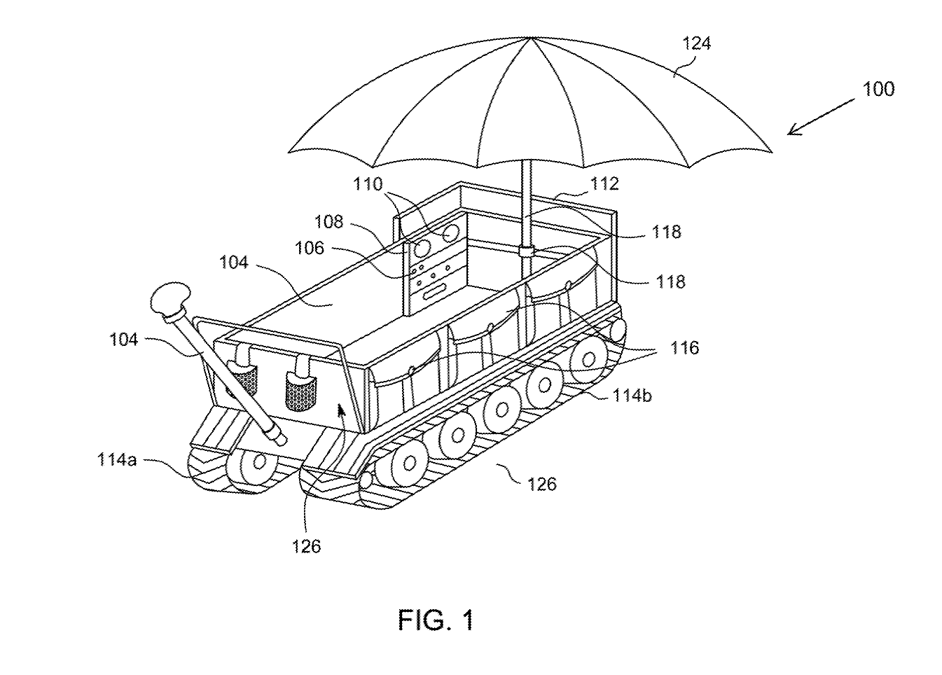

FIG. 1 illustrates a perspective view 100 of a beach tank 102 anchored on a surface 126, according to an embodiment herein. The surface 126 is a sandy surface at a beach. According to an embodiment herein, the surface 126 is a pavement, lawn or a tarred surface. The beach tank 102 includes a wagon 104 mounted on a pair of caterpillar tracks 114a and 114b, electric motor mounted on an underside of the wagon 104, a plurality of storage compartments 116, a solar panel 122, a charging station 108, speakers 110, a handle 112, a beach umbrella 124, a support rod 120, and a strap 118.

As shown in FIG. 1, each caterpillar track 114a and 114b is arranged underneath a longitudinal edge of the wagon 104. The caterpillar track 114a and 114b is designed to ensure navigation of the wagon 104 across a plurality of terrains such as sand, gravel, rocks, stairs, pavements, lawns, grass and the like. Further, the electric motor (not shown) is mounted on an underside of the wagon 104 and is configured to operate the pair of caterpillar tracks 114a and 114b for moving the wagon 104 on the plurality of terrains. According to an embodiment herein, the pair of caterpillar tracks 114a and 114b have a dual or single track design. According to an embodiment herein, the electric motor is battery operated. Rechargeable batteries are used to provide necessary electric power. According to an embodiment herein, the rechargeable batteries are charged by the solar panel 122. According to an embodiment herein, the electric motor is remote controlled.

Further, the plurality of storage compartments 116 are positioned along an exterior surface of the wagon 104 as shown. Each storage compartment is configured to house a plurality of beach items such as blankets, towels, food, water, cleaning solution, carpets, chairs, beverages, umbrellas, tables, mobile phones, stereos, body lotions, amusement goods, sports goods, toys, and clothes. The handle 112 is provided at a front end of the wagon 102. The handle 112 is configured to facilitate maneuvering of the wagon 102 manually.

Further, the beach umbrella 124 supported by a support rod 120 attached to an interior side of the wagon 104 for providing shade to a person sitting inside the wagon 104. According to an embodiment herein, the strap 118 is provided at the interior end of the wagon 104 to anchor the support rod 120 of the beach umbrella 124. According to an embodiment herein, the beach umbrella 124 is folded into a binding cylinder and clamped into the binding cylinder, when not in use.

Further, the charging station 108, includes one or more electrical power outlets, a Universal Service Bus (USB) port, speakers 110, Wi-Fi, and Bluetooth™ connectivity. The speakers 110 are used for playing a plurality of musical sounds and songs. The USB ports and the one or more electrical power outlets is used to charge mobile phones, laptops, DVD players and the like. The Wi-Fi port is configured to ensure connectivity to the internet while at the beach. Further Bluetooth connectivity ensures connecting to any electrical appliance within the beach tank 102 using a mobile device.

According to an embodiment herein, the solar panel 122 is mounted behind the USB port and configured to provide electric power to the charging station 108 and a plurality of rechargeable batteries that are configured to operate the electric motor and the electrical and electronic appliances housed in the beach tank. According to an embodiment herein, the solar panel 122 is further configured to flip open when the beach tank 102 is stationed at a desired location.

According to an embodiment herein, a length of the wagon 104 is five feet, and a width of the wagon 104 is within a range of two to three feet. The height of the wagon 104 is three feet.

According to an embodiment herein, the wagon 104 is made of a lightweight weatherproof plastic material. Examples of plastic materials used include Acrylonitrile butadiene styrene (ABS), acrylic, polypropylene, phenolic resins or amino resins. The plastic materials generally display good colors and are reasonably priced. For example, ABS is typically a hard, rigid and tough variety of plastic that has excellent colorability and durability. Further, such materials are readily fabricated by a number of manufacturing processes such as injection molding. Typically, a material used for manufacturing the beach tank 102 depends on a number of factors such as durability, strength, rigidity and cost.

According to an embodiment herein, the wagon 104 is made of a lightweight metal. For example, the beach tank 102 is produced from aluminum using die casting, which is a highly mechanized, quick process ideal for mass-production of components and a molten metal is forced under considerable pressure into a steel mold or die in the process.

According to an embodiment herein, the wagon 104 and the plurality of storage compartments 116 are provided in a plurality of colors to provide an appeal to a wide range of users.

According to an embodiment herein, the beach tank 102 is configured to tailgate a motorized vehicle.

According to an embodiment herein, the beach tank 102, is designed to include a water bottle cleaning solution that is used to wash off sand from the body. Further, a temperature controlled liquid bag section is filled with cold water that is used for drinking or washing sand off and a user's body.

The technical advantages envisaged by the embodiments herein include an easy pull off of the beach tank 102 on a sandy surface without having any of the wheels of the pair of caterpillar tracks 114a, 114b sinking into sand. The easy pull of property reduces an effort required by a user while pulling the beach tank 102.

Further, the beach tank 102 is envisaged to be used for camping or when attending races such as NACAR Races.

The availability of the charging station 108, ensures connectivity at remote places thereby facilitating use of the beach tank 102 as a convenient product even while trekking and camping.

Further, use of weatherproof plastic material for the wagon of the beach tank 102 makes it a versatile product that is used all round the year during any season.

The durable material used for constructing the beach tank 102, ensures larger life span to the product thereby making it an economical and valuable investment.

As the structure of the wagon 104 is structured to easily collapse inwards when not in use, it becomes easy and convenient to store in a car.

The foregoing description of the specific embodiments will so fully reveal the general nature of the embodiments herein that others can, by applying current knowledge, readily modify and/or adapt for various applications such as specific embodiments without departing from the generic concept, and, therefore, such adaptations and modifications should and are intended to be comprehended within the meaning and range of equivalents of the disclosed embodiments.

It is to be understood that the phraseology or terminology employed herein is for the purpose of description and not of limitation. Therefore, while the embodiments herein have been described in terms of preferred embodiments, those skilled in the art will recognize that the embodiments herein can be practiced with modifications. However, all such modifications are deemed to be within the scope of the claims.

What is claimed is:

1. An all-terrain multipurpose utility beach tank comprising:
a wagon mounted on a pair of caterpillar tracks, and wherein the pair of caterpillar tracks are arranged underneath a longitudinal edge of the wagon, and wherein the wagon is designed in rectangular or square;
an electric motor mounted on an underside of the wagon and configured to operate the pair of caterpillar tracks for moving the wagon on a plurality of terrains; and
a plurality of storage compartments provided along an exterior surface of the wagon, and wherein each storage compartment is configured to house a plurality of utility items configured for use in a beach.

2. The beach tank of claim 1 further comprises a handle provided at a front end of the wagon, and wherein the handle is configured to facilitate maneuvering of the wagon manually.

3. The beach tank of claim 1 further comprises a beach umbrella supported by a support rod attached to an interior side of the wagon for providing shelter to a user, and a strap is provided at the interior end of the wagon to anchor the support rod of the beach umbrella.

4. The beach tank of claim 3, wherein the beach umbrella is folded into a binding cylinder and clamped into the binding cylinder.

5. The beach tank of claim 1 further comprises a charging station comprising one or more electrical power outlets, a Universal Service Bus (USB) port, speakers, Wi-Fi, and Bluetooth™ connectivity.

6. The beach tank of claim 5 further comprises a solar panel mounted behind the USB port and configured to provide electric power to the charging station and a plurality of rechargeable batteries, and wherein the rechargeable batteries are configured to supply electrical power for operating the electric motor and a plurality of electrical and electronic appliances housed in the wagon.

7. The beach tank of claim 6, wherein the solar panel is further configured to flip open when the beach tank is stationed at a desired location.

8. The beach tank of claim 1, wherein a length, a width of the wagon and a height of the wagon are customized based on a requirement of the user.

9. The beach tank of claim 1, wherein the wagon is made of at least one of a lightweight weatherproof plastic material and a metallic material.

10. The beach tank of claim 1, wherein the wagon and the plurality of storage compartments are provided in a plurality of colors.

11. The beach tank of claim 1, wherein the plurality of utility items comprise one or more of blankets, towels, food, water, cleaning solution, carpets, chairs, beverages, umbrellas, tables, mobile phones, stereos, body lotions, amusement goods, sports goods, toys, and clothes.

12. The beach tank of claim 1 further comprises a hook or an attachment configured to tailgate a motorized vehicle.
